(19) United States
(12) Patent Application Publication
(10) Pub. No.: US 2025/0147064 A1
(43) Pub. Date: May 8, 2025

(54) SENSOR DEVICE AND SENSOR ASSEMBLY

(71) Applicant: Emfit Ltd., Vaajakoski (FI)

(72) Inventors: Jukka RANTA, Vaajakoski (FI); Mikko ALASAUKKO-OJA, Vaajakoski (FI); Jouni MITJONEN, Vaajakoski (FI); Heikki RÄISÄNEN, Vaajakoski (FI)

(73) Assignee: Emfit Ltd., Vaajakoski (FI)

(21) Appl. No.: 18/939,446

(22) Filed: Nov. 6, 2024

Related U.S. Application Data
(60) Provisional application No. 63/547,546, filed on Nov. 6, 2023.

(51) Int. Cl. G01P 15/09; G01P 1/02; G08B 21/22

(52) U.S. Cl. CPC G01P 15/09; G01P 1/023; G08B 21/22

(57) ABSTRACT

A sensor device (100) for monitoring an occupancy of a resting place by a monitoring subject includes an integrated unit (99) comprising a sensor element (101) for sensing micromovements of the subject when resting in the resting place, and an electronic unit (102) comprising a computing device, a main body (104) wherein the sensor element (101) is disposed in a sensor housing (110) substantially peripheral of the main body (104).

### CROSS-REFERENCE TO RELATED APPLICATIONS

This application claims priority to U.S. Ser. No. 63/547,546 filed on Nov. 6, 2023, which is pending and is hereby incorporated by reference in its entirety for all purpose.

### BACKGROUND OF THE INVENTION

### 1. Field of the Invention

The invention is directed to a sensor device for monitoring movement activity of a subject in a bed or chair.

More particularly, the invention is directed a sensor device for monitoring movement activity of a subject in a bed or chair wherein (i) the sensor device has reduced manufacturing costs relative to conventional sensor devices by integrating, into an integrated unit, the sensor element for sensing micromovements of the subject and an electronic unit, (ii) improved durability of the sensor device, and/or (iii) a form factor that is more discreet and user friendly for better adaption to wider beds where the subject can sleep in a wider sleeping area.

### 2. Discussion of the Related Art

Accurate and real-time monitoring of a patient in a healthcare facility or the activity of a resident in an assisted living facility is of paramount importance to the facility, the patient or resident, and/or society. Thus, bed occupancy sensors and exit sensors, i.e. bed leaving sensor have become vital tools in ensuring the safety and well-being of patients and/or residents and ensuring that quality of care, in general, is provided to individuals in healthcare and long-term care settings.

Bed and/or chair occupancy sensors serve as an indispensable means of continuously monitoring a patient's or resident's presence in a bed or in a chair. These are designed to detect whether an individual is resting in bed or in a chair or has left these, providing valuable insights into the patient's activity and helping healthcare providers respond promptly to their needs. Furthermore, bed and/or chair occupancy sensors offer a non-intrusive and efficient way to gather data on sleeping patterns, bed exits, and overall bed usage.

Exit sensors, on the other hand, play a critical role in enhancing patient safety and fall prevention. These sensors are strategically placed to detect when an individual attempts to leave a bed or chair, signaling the potential risk of a fall. By triggering alerts, exit sensors enable immediate intervention, reducing the likelihood of accidents and injuries in healthcare and senior living facilities.

In the present era, with a growing awareness of environmental issues and resource conservation, the need for sustainable and responsible product design is paramount. In various industries, including the healthcare and sensor technology sector, there is an increasing emphasis on minimizing waste, reducing the consumption of non-renewable resources, and extending the lifespan of products.

The proliferation of low-cost weight-sensing bed and chair occupancy sensors and exit sensors on the market has undoubtedly expanded the accessibility of such technology. However, many of these sensors come with a significant drawback—their limited durability. Often designed with the objective of cost reduction, these sensors tend to have a short lifespan, typically lasting no more than a year. This short lifecycle results in a substantial accumulation of electronic waste, predominantly composed of plastics and non-recyclable components, contributing to the global issue of electronic waste, also known as e-waste.

The environmental consequences of e-waste are alarming, as it leads to pollution, and resource depletion, and poses a significant challenge in waste management. Moreover, the production of disposable sensors entails the consumption of valuable materials, particularly plastics, and electronic components, that are often difficult to recycle.

Thus, what is needed is a low-cost sensor with a long service life or a longer service lifespan, i.e. increased service lifespan, than is currently in use. That is, a need exists for a low-cost medical grade sensor or sensor assembly with with a long or longer service lifespan, i.e. increased.

### SUMMARY OF THE INVENTION

In accordance with one or more embodiments of the present invention, the invention is directed a sensor device for monitoring movement activity of a subject in a bed or chair wherein the sensor device has reduced manufacturing costs relative to conventional sensor devices by integrating, into an integrated unit, the sensor element for sensing micromovements of the subject and an electronic unit, improved durability of the sensor device, (iv) a form factor that is more discreet and user friendly for better adaption to wider beds where the subject can sleep in a wider sleeping area.

It is known that using piezoelectric materials such as PVDF or PZT, the sensor can detect not only occupancy but also micromovements of the heart and breathing. Sensors based on printed force-sensing resistive material, or using optical light cable are also existing. Also, MEMS sensors are used for detecting micromovements of a body on a bed or chair.

A innovation in the present sensor technology is the use of our manufactured quasi-piezoelectric film, specifically designed as a cellular ferro-electret type. This unique material enables the sensor to detect micromovements caused by the user's heart movements, rendering it a dynamic ballistocardiogram sensor. By sensing user presence based on these micromovements, our sensor provides real-time feedback regarding the occupant's status in a bed or on a chair.

A sensor device for monitoring an occupancy of a resting place by a monitoring subject, the sensor device comprising:
an integrated unit comprising
   a sensor element for sensing micromovements of the subject when resting in the restplace, and
   an electronic unit comprising a computing device,
a main body wherein the sensor element is disposed in a sensor housing substantially peripheral of the main body.

The sensor device wherein the sensor element comprises cellular a ferro-electret material.

The sensor device further comprises an outer layer of main body comprising polypropylene.

The sensor device further comprises softer layers to contact a resting surface.

The sensor device further comprises a hinge of a thin and flexible at a sensor housing to allows the electronics unit to be seamlessly integrated inside the sensor housing.

The sensor device further comprises a hinge of a thin and flexible at the sensor housing to allows the electronics to be seamlessly integrated inside the sensor housing.

The sensor device further comprises a control unit body areas located at a corner of the main body.

The sensor device wherein the outer layer is 1 mm polypropylene.

The sensor device further comprises softer layers to contact a resting surface.

The sensor device further comprises a hinge of a thin and flexible at a sensor housing to allows the electronics unit to be seamlessly integrated inside the sensor housing.

### BRIEF DESCRIPTION OF THE DRAWINGS

FIG. 1A is a plan view of a sensor device in accordance with one or more embodiments of the present invention.

FIG. 1B is a plan view of the sensor device of FIG. 1A illustrating the sensing area to illustrate the area in which the sensing element is disposed in accordance with one or more embodiments of the present invention.

FIG. 2 is a first perspective view of the sensor device in accordance with one or more embodiments of the present invention.

FIG. 3 is a second perspective view of the sensor device in accordance with one or more embodiments of the present invention.

FIG. 4 is a third perspective view of the sensor device in accordance with one or more embodiments of the present invention.

FIG. 5A is a plan view of a sensor device in accordance with one or more embodiments of the present invention.

FIG. 5B is a detail view of a sensor device of FIG. 5A.

FIG. 6A is a front plan view of a sensor device in accordance with one or more embodiments of the present invention wherein broken lines are used to illustrate that the main body are may have any suitable size and shape.

FIG. 6B is a first side view of the sensor device of FIG. 6A in accordance with one or more embodiments of the present invention wherein broken lines are used to illustrate that the main body are may have any suitable shape.

FIG. 6C is a second side view of the sensor device of FIG. 6A in accordance with one or more embodiments of the present invention wherein broken lines are used to illustrate that the main body are may have any suitable shape.

FIG. 6D is a rear plan view of the sensor device of FIG. 6A in accordance with one or more embodiments of the present invention wherein broken lines are used to illustrate that the main body are may have any suitable size and shape.

### DETAILED DESCRIPTION OF THE INVENTION

Although, the embodiments that are discussed are relative to a human patient in a healthcare facility or assisted care facility the application is not limited narrowly to such settings. For example, all of the embodiments may be used with regard to one or more animals who are the patient.

One example is hospital out-patient monitoring when the patient returns home after a surgical procedure. In accordance with one or more embodiments of the present invention, the present invention may be used before that, for example, while patient stays in a hospital before going home.

### Definitions

All technical and scientific terms shall have the same meaning as commonly understood by one of ordinary skill in the art. Nonetheless, the following terms are defined below to aid in the understanding of the disclosure and the definitions apply to all parts of speech of the term regardless whether the term is defined explicitly as such.

“About,” “approximately,” or “substantially similar” refer to a 10% variation from the nominal value. Even if not explicitly stated, it is understood that a variation is always included in a given value, whether or not the variation is specifically referenced.

Herein, “healthcare facility” or the like may also, besides its plain meaning, means one or more hospitals, trauma centers, ambulatory surgical centers, nursing home, convalescence home, or any other facility offering treatment for medical, psychological, addiction, behavioral issues, or any other treatment options now know or to be devised where professionals are readily and/or immediately available in person or via a communications device to a patient to render or effect assistance.

Herein, “assisted living facility” may also, besides its plain meaning, mean any other location besides “healthcare facility” and wherein such a location is preferably defined as one or more physical locations where professionals are less readily and/or immediately available than in a healthcare facility in person or via a communications device to a patient to render or effect assistance but nonetheless provide professional and/or para-professional care.

Herein, “a user” seeks another person's health (collectively “a subject,” or “a resident” or “a patient” more specifically) may use an electrical device, electromechanical device, or software running on a device of the subject.

Herein, a “patient” or preferably “subject” may be one or more human patients but may also be one or more veterinary patients, i.e., animals such as race horses. A “subject” may be but is not necessarily synonymous with a “user” and vice versa. Indeed, “user” may refer in the singular to one or more persons and/or entities, such as a patient, a subject, and a hospital organization in combination. However, for simplicity and general readability of this application, user and subject are interchangeably used. It should be appreciated that the reader should consider the user and subject are not interchangeable as well as that they are interchangeable.

Forms of the verb “to monitor, “to capture,” or “to record” mean to (a) acquire data through one or more sensors and/or (b) save that data to one or more files having any suitable format to any suitable non-transitory computer-readable memory.

“Computing device,” or interchangeably “hardware,” is intended in this disclosure for all purposes to be interpreted broadly and is defined for all uses, all devices, and/or all systems and/or systems in this disclosure as a device comprising at least a central processing unit, a communications device for interfacing with a data network, transitory computer-readable memory, and/or a non-transitory computer-readable memory and/or media. The central processing unit carries out the instructions of one or more computer programs stored in the non-transitory computer-readable memory and/or media by performing arithmetical, logical, and input/output operations to accomplish in whole or in part one or more steps of any method described herein. A computing device may have an onboard power source, access power from any suitable source, a draw power using a rechargeable battery or wall adapter.

A computing device is usable by one or more users, other computing devices directly and/or indirectly, actively and/or passively for one or more suitable functions herein. The computing device may be embodied as computer, a laptop, a tablet computer, a smartphone, camera, imaging device, and/or any other suitable device and may be a networked computing device, a server, or the like. Where beneficial, a computing device preferably includes one or more human input devices such as a computer mouse and/or keyboard and one or more human interaction device such as one or more monitors. A computing device may refer to any input, output, and/or calculating device associated with providing a virtual reality experience to one or more users.

Although one computing device may be shown and/or described, multiple computing devices may be used. Conversely, where multiple computing devices are shown and/or described, a single computing device may be used.

“Computer program,” or interchangeably “software,” means any set of instructions stored in a non-transitory computer-readable memory or non-transitory computer-readable media for executing one or more suitable functions and/or for executing one or more methods in this disclosure. Even if not explicitly mentioned, in this disclosure, a computing device includes software having any set of instructions stored in non-transitory computer-readable memory or non-transitory computer-readable media for executing one or more suitable functions and/or for executing one or more methods in this disclosure.

“Non-transitory computer-readable memory,” or interchangeably “non-transitory computer-readable media,” may be a hard drive, solid-state drive, compact disk drive, DVD drive, and/or the like for storing the one or more computer programs.

“Sensor” means the devices defined herein, but may also mean, to the extent usable with the present invention, a transducer used for converting one or more mechanical movements or sounds to electrical analog signals corresponding to the mechanical movements and encompasses all types of transducers.

“Device” shall beyond its common meaning also mean an item that protects one or more other units, such a sensor, retained within a housing comprising one or more parts, one or more ports to access the unit retained within the housing, and one or more buttons to control the device.

“Lifespan” and/or “service lifespan” of a device, for example a sensor, is defined as the mean service life of an object. An improvement therein may be at least 10% increase in the service life.

### Discussion of the Invention

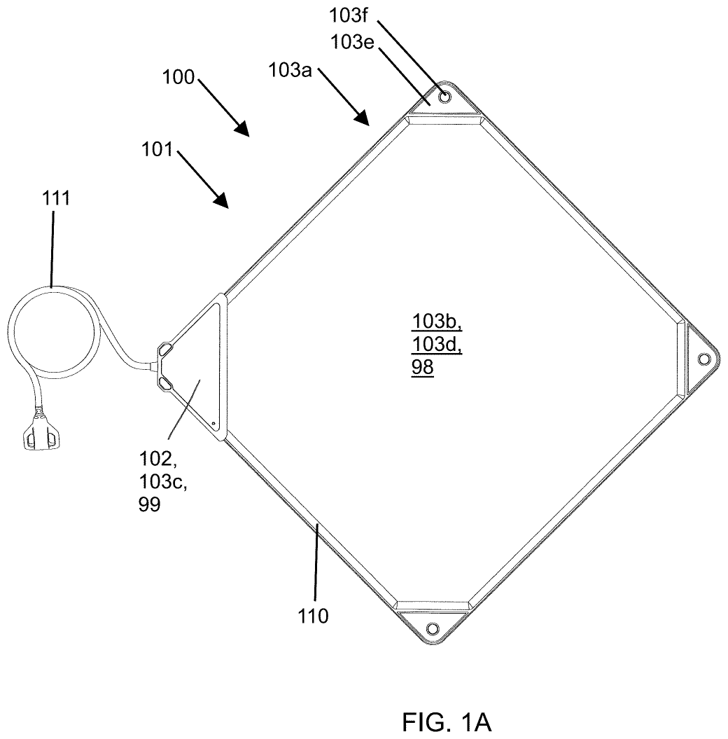

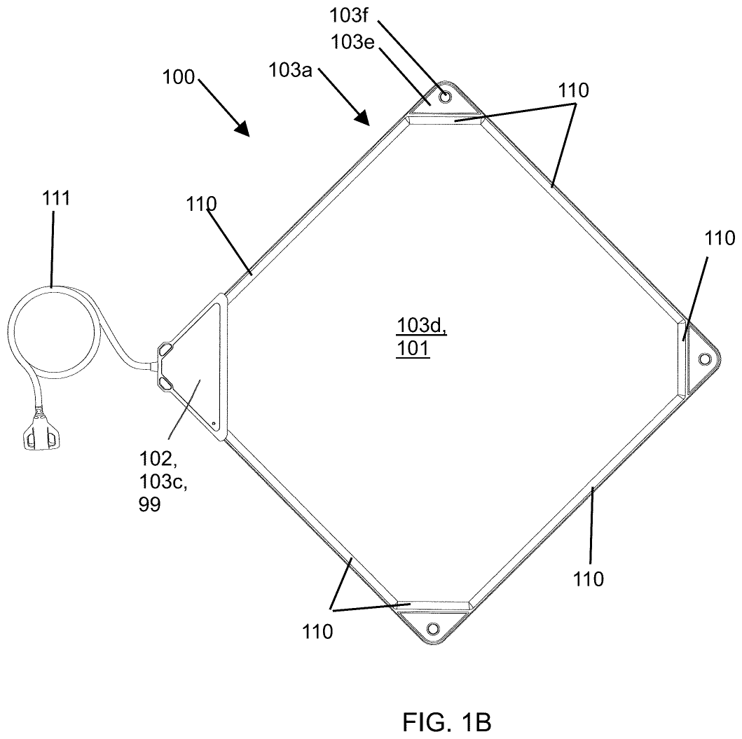

FIG. 1A is a plan view of a sensor device in accordance with one or more embodiments of the present invention.

FIG. 1B is a plan view of the sensor device of FIG. 1A illustrating the sensing area to illustrate the area in which the sensing element is disposed in accordance with one or more embodiments of the present invention.

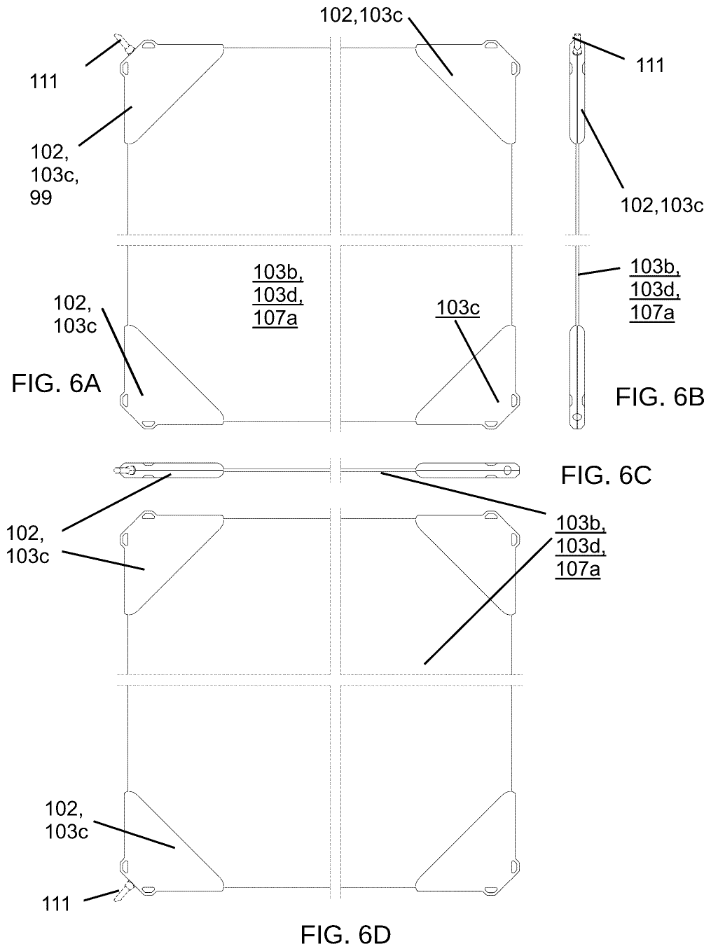

FIG. 6A is a front plan view of a sensor device in accordance with one or more embodiments of the present invention wherein broken lines are used to illustrate that the main body are may have any suitable size and shape.

FIG. 6B is a first side view of the sensor device of FIG. 6A in accordance with one or more embodiments of the present invention wherein broken lines are used to illustrate that the main body are may have any suitable shape.

FIG. 6C is a second side view of the sensor device of FIG. 6A in accordance with one or more embodiments of the present invention wherein broken lines are used to illustrate that the main body are may have any suitable shape.

FIG. 6D is a rear plan view of the sensor device of FIG. 6A in accordance with one or more embodiments of the present invention wherein broken lines are used to illustrate that the main body are may have any suitable size and shape.

In accordance with one or more embodiments of the presently claimed invention, a sensor device 100 is used for one or more applications in a healthcare management system to determine a bed-related or chair-related status of a subject, i.e. a patient in a healthcare facility or a resident in an assisted living facility. That is, sensor device 100 monitors the occupancy of a resting place of a subject. A resting place is used to mean a purpose-built furniture where a subject, for example, a patient in a healthcare facility or a resident in an assisted living facility, is seeking rest, for example, a bed or a chair or a lounger.

Sensor device 100 may be used in healthcare management system wherein it may be used in the health care management system that is disclosed in U.S. Pat. No. 11,908,576 B2 to Emfit Ltd., the applicant of the present application. Therein it may be a monitoring subsystem for a healthcare management system comprising a sensor device 100.

The bed-related or chair-related status, i.e. resting place, is defined as one of the following:
(i) subject is, at time of monitoring, in bed or chair, respectively, or
(ii) subject is not, at time of monitoring, in bed or chair, respectively.

Sensor device 100 has the advantages of
(i) having reduced manufacturing costs relative to conventional sensor devices by integrating, into integrated unit 99, sensor element 101 for sensing micromovements of the subject and an electronic unit 102, which is a control unit, data capture unit, and/or analysis unit;
(ii) improved durability of sensor device 100; and
(iii) a form factor 103a that is more discreet and user friendly for better adapting to wider beds where the subject can sleep in a wider sleeping area.

Therein, sensor device 100 is a comprehensive solution that enhances both the safety and quality of care. By extending the service life of sensor 100, a significant reduction in waste generation is achieved. Sensor device 100 helps curb the overconsumption of plastics and electronic components that would otherwise end up as e-waste in landfills. This environmentally conscious approach aligns with the global movement towards reducing the environmental footprint of manufactured products.

In accordance with one or more embodiments of the present invention, sensor device 100 comprises an integrated unit 99 comprising a sensor element 101 for sensing micromovements of the subject and an electronic unit 102, which is a control unit, data capture unit, and/or analysis unit.

In accordance with one or more embodiments of the present invention, sensor device 100 comprises an integrated unit 99 operatively consisting of a sensor element 101 for sensing micromovements of the subject and an electronic unit 102, which is a control unit, data capture unit, and/or analysis unit.

Advantageously, electronic unit 102 is integrated as integrated unit 99 into the same form with sensor element 101 to remove the signal cable between the sensor and electronics.

Therein, a requirement is that sensor element has to remain flexible as it often is used on a mattress at just below the mattress topper. Thus, electronic unit 102 was developed such that it has control unit body area 103c preferably in the shape of a triangle as illustrated in FIGS. 1 and 6A-6D.

In accordance with one or more embodiments of the present invention, sensor element 101 is preferably based on cellular ferro-electret materials (for example as one made by EMFIT®) but could be also for example films like piezoelectric materials like PZT or PVDF, alone or in combination with each other. Sensor element 101 detects, i.e. captures, sensing micromovements of the subject as the subject moves while in bed or has a heart beat.

Electronic unit 102 comprises a signal processing module having a main board and wireless transmission modules such as WiFi and/or Bluetooth, or LTE-M.

Sensor device 100 may have any suitable shape, but preferably has form factor 103a comprising main body 103b, which includes a control unit body area 103c and a sensing body area 103d in which sensing element 101 is disposed.

FIG. 1B is a plan view of the sensor device of FIG. 1 illustrating the sensing area to illustrate the area in which the sensing element is disposed in accordance with one or more embodiments of the present invention. Sensing element 101 may have any suitable arrangement in any suitable pattern but preferably is contained in sensor housing 110 at the perimeter

In the embodiment of FIG. 1A, form factor 103a is a square shape and the control unit body area 103c comprising a triangular shape. A corner reinforced area 103e is disposed at one or more of main body area 103b.

An aperture 103f, preferably in the form of a reinforced circular opening, is disposed in corner reinforced area 103e and is used to secure main body area 103b from unintended movement via a strap, code, pins, and/or other retainer to a bed frame, a mattress, a chair frame, and/or any other suitable point.

Sensor device 100 preferably includes a cable 111 to provide a power connection, a data connection, and/or a combination of power and data, alternately or simultaneously. In accordance with one or more embodiments of the present invention, cable 111 may be permanently mounted to main body area 103b at control unit body area 103c.

Alternatively, cable 111 may be removably mounted to main body area 103b at control unit body area 103c via a socket (not shown) embedded at control unit body area 103c. This may be USB socket and is preferred for its ready availability, economics, and ease of use, but may be any other suitable unit.

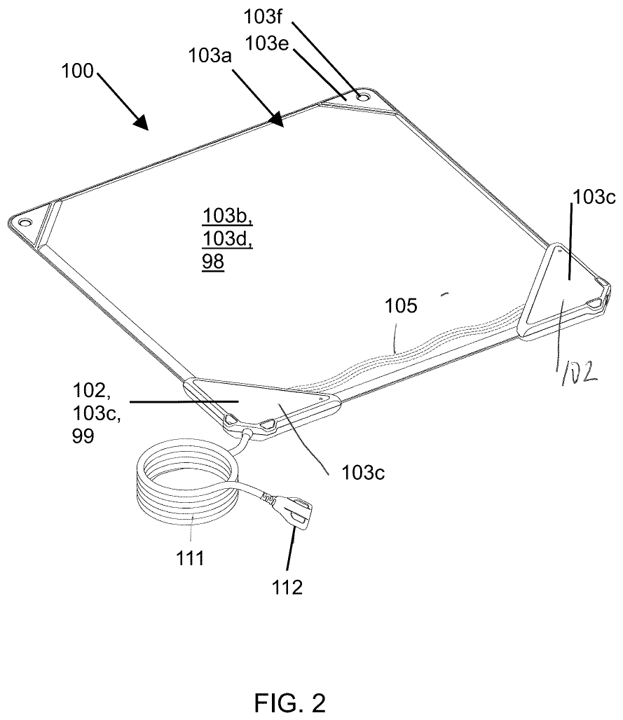

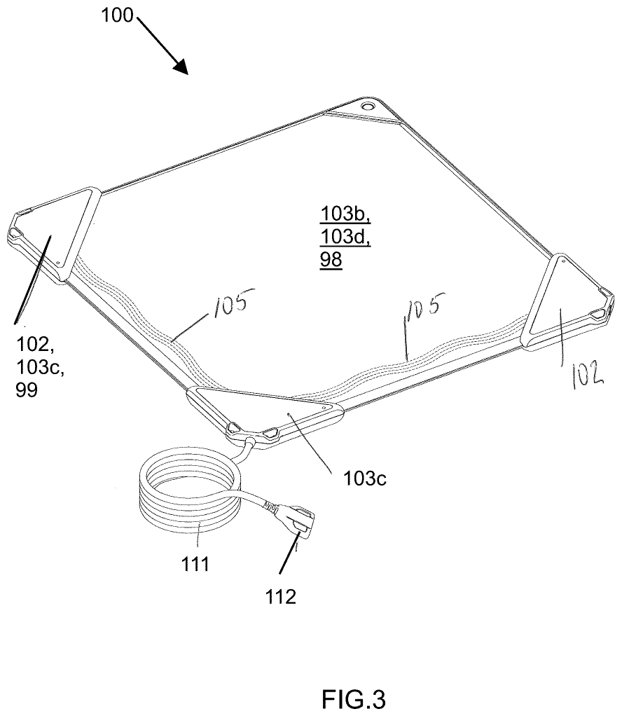

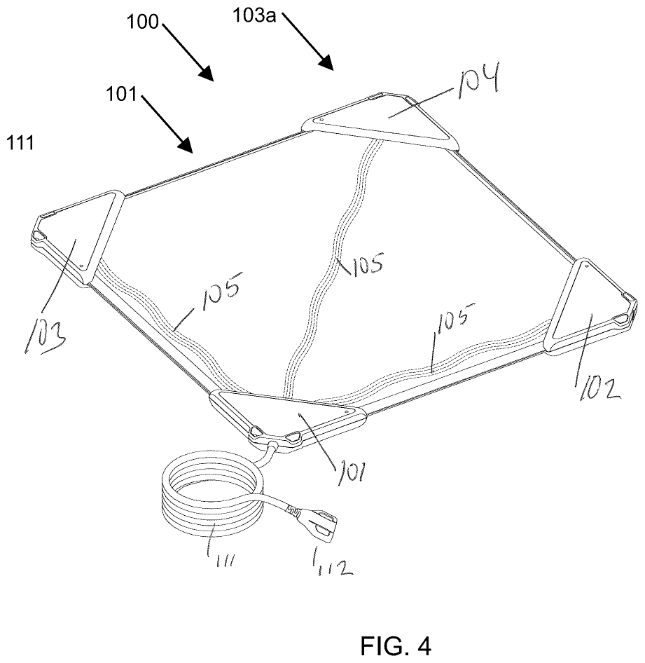

FIGS. 2, 3, and 4 are perspective views of the sensor device in accordance with one or more embodiments of the present invention. Therein, electronic unit 102 may be disposed in multiple control unit body area 103c located at two or more corners connected with wiring 105 inside the main body. FIGS. 6A-6D illustrate control unit body areas 103c located at all four corners.

In multiple control unit body areas 103c, for example LTE-M is connected with UART wiring 105, or to wireless radio operating at 868 MHz reserved for social alarms. Alarms can be triggered with an optocoupler connected to one IO pin in the CPU arranged at the main board of electronic unit 102.

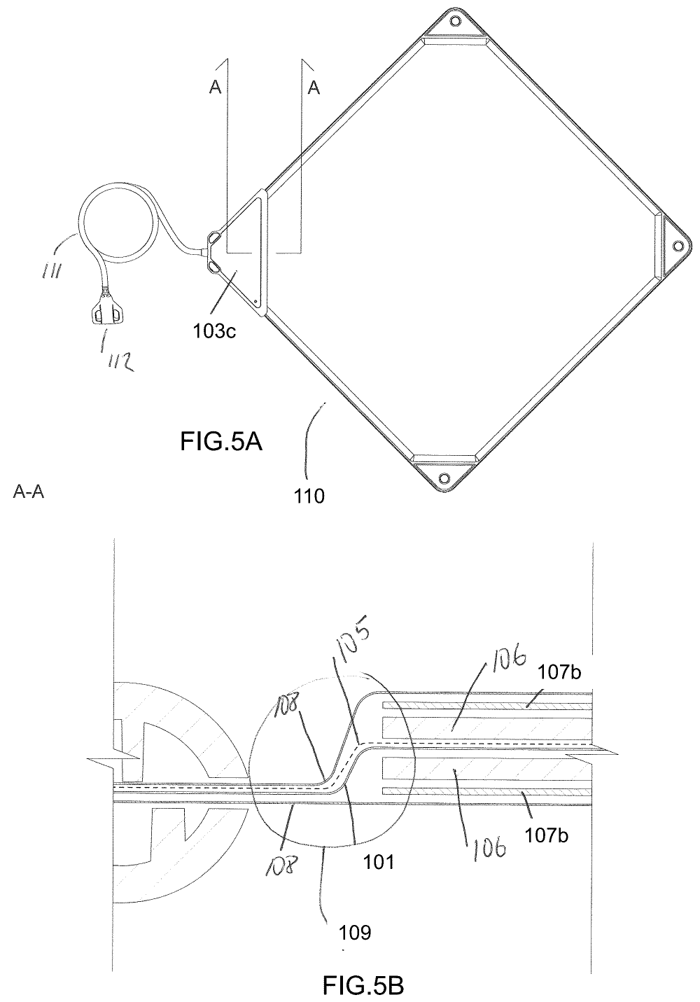

FIG. 5A is a plan view of a sensor device in accordance with one or more embodiments of the present invention. FIG. 5B is a detail view of a sensor device of FIG. 5A.

Wiring 105 provides power to the additional electronics from the main board, i.e. a computing device, of electronic unit 102. Power to the main board of electronic unit 102 is brought with for example USB-C female connector 112 in the end of cable 111.

Sensor device 100 has a main body 104 for example as the main body area 103b, having additional soft layers 106, preferably on both sides of the sensing body area 103d, enhances the signal clarity quality, and strength (amplitude) in many use cases where the mattress is very thick or the bed head is raised.

Soft layers 106 improve contact with the mattress, bed bottom, or box spring (i.e. resting surface), ensuring more precise detection of forces generated by the user's heartbeats and breathing. Advantageously, this feature is especially valuable in the context of hospital beds, where thick mattresses or elevated bed heads may hinder signal clarity. The additional soft layers facilitate improved contact, resulting in cleaner and stronger signals. Soft layers 106 may be any suitable material, but preferably may be cotton, wool, closed-cell foam, open-cell foam, cloth, polyurethane foam, poly-fil filling.

To enhance durability, sensor device 100 comprises an outer layer 98 of main body 104 of a thicker polypropylene but can be other harder materials such as polyester or polycarbonate or even wood such as veneer reinforcement layers 107b on top of soft layers 106 and encapsulate the entire main body 105 within thin PVC (polyvinylchloride) 108 or PU (polyurethane) or alternative materials, ensuring the long-lasting performance of the sensor. Outer layer 98 may comprise polypropylene of 0.25 mm to 2.5 mm thickness and any thickness in that range.

Sensor device 100 comprises a hinge 109. In one or more corners of the sensor, where electronics units 102 are located, soft layers 106 are not present, creating a thin and flexible section 109 that allows the electronics to be seamlessly integrated inside the sensor housing 110.

Hinge 109 ensures the sensor's reliability and longevity while maintaining its sensitivity and effectiveness in detecting user movements and presence. In the hinge area, additional reinforcement layers, for example, the same about 1 mm thick polypropylene as on the sensing area 107a are on both sides of the sensor. These continue inside the triangle-shaped control unit body area 103c.

As there are many thicknesses in mattresses, and many kinds of bed bottoms (solid versus wire mesh), users can be very different weights, or the user's heart can be weak or strong. Hence the sensor signal can be weak or strong. For example, illnesses like heart failure affect a lot in the signal strength and peak shapes. To overcome these problems, electronic unit 102 includes algorithms and processes for signal acquisition that are ongoing in the electronics unit 102. These enhancements include for example automatic gain adjustments, prioritized events over sending 100 Hz sampled ballistocardiograph signal after buffering has occurred, beat-to-beat series in milliseconds, AFIB detection, obstructive sleep apnea diagnosis, and heart failure decompensation analysis.

The present invention provides a significant advancement in the field of bed occupancy and exit and contact-free vital signs sensors, addressing durability, signal quality, and user comfort challenges, and redefining the standards for patient and resident monitoring in healthcare and assisted living environments.

What is claimed is:

1. A sensor device (100) for monitoring an occupancy of a resting place by a monitoring subject, the sensor device (100) comprising:
an integrated unit (99) comprising
a sensor element (101) for sensing micromovements of the subject when resting in the resting place, and
an electronic unit (102) comprising a computing device,
a main body (104) wherein the sensor element (101) is disposed in a sensor housing (110) substantially peripheral of the main body (104).

2. The sensor device (100) of claim 1, wherein the sensor element (101) comprises cellular a ferro-electret material.

3. The sensor device (100) of claim 1, further comprising an outer layer (98) of main body (104) comprising polypropylene.

4. The sensor device (100) of claim 1, further comprising softer layers (106) to contact a resting surface.

5. The sensor device (100) of claim 1, further comprising a hinge (109) of a thin and flexible at a sensor housing (110) to allows the electronics unit (99) to be seamlessly integrated inside the sensor housing (110).

6. The sensor device (100) of claim 1, further comprising a hinge (109) of a thin and flexible at the sensor housing (110) to allows the electronics to be seamlessly integrated inside the sensor housing (110).

7. The sensor device (100) of claim 1, further comprising a control unit body areas (103c) located at a corner of the main body (104).

8. The sensor device (100) of claim 3, wherein the outer layer (98) is 1 mm polypropylene.

9. The sensor device (100) of claim 8, further comprising softer layers (106) to contact a resting surface.

10. The sensor device (100) of claim 9, further comprising a hinge (109) of a thin and flexible at a sensor housing (110) to allows the electronics unit (99) to be seamlessly integrated inside the sensor housing (110).
